(19) United States
(12) Patent Application Publication
(10) Pub. No.: US 2005/0036631 A1
(43) Pub. Date: Feb. 17, 2005

(54) System and method for testing motor vehicle loudspeakers

(75) Inventors: Steven Feit, Dubin, OH (US); Andrew T. Geoppner, Plain City, OH (US); Jason A. Dutter, Marysville, OH (US)

Correspondence Address: Plumsea Law Group, LLC, Suite 320, 10411 Motor City Drive, Bethesda, MD, 20817, US

(73) Assignee: Honda Giken Kogyo Kabushiki Kaisha, Tokyo (JP)

(21) Appl. No.: 10/638,641

(22) Filed: Aug. 11, 2003

(51) Int. Cl. H04R 29/00; H04B 1/00

(52) U.S. Cl. 381/86; 381/58

(57) ABSTRACT

A system and method for testing an audio system in a motor vehicle is disclosed. The system and method can be used to send a test signal to a particular loudspeaker. Controls allow a user to test each loudspeaker individually and to move the test signal from one loudspeaker to another easily. The system and method can include a particular key or button sequence to enter the diagnostic mode. The system also includes provisions that allow users to easily direct a test signal to a particular loudspeaker.

### BACKGROUND

1. Field of the Invention

This invention relates to a system and method for testing loudspeakers, more particularly, to a system and method for testing loudspeakers in a motor vehicle.

2. Related Art

Testing and quality assurance are important aspects of manufacturing. In the field of motor vehicle manufacturing, testing of all of the various components and subsystems that comprise a motor vehicle is essential. In order to insure high quality and to reduce the number of defective products, every single subsystem and component is generally tested.

With the dramatic increase in both the number of subsystems and their growing complexity, it becomes more and more difficult to test each subsystem, much less, test those subsystems quickly.

The audio system in a motor vehicle is one of those systems that have increased in complexity over the years. It is common for current motor vehicle audio systems to include multi-channel amplifiers and multi-function head units that can play a variety of sources and media. Adding additional capabilities to these head units has caused the controls on the head unit to serve many different functions. Because the buttons and dials are assigned many different functions, some functions can be difficult or inconvenient to access.

The audio system in a motor vehicle must be tested to insure that all of the components of the audio system are functioning properly, including all of the loudspeakers associated with the audio system. Typically, a technician has used the fader and balance controls on the head unit to test the loudspeakers. In many cases, this can be a time consuming task.

With the increased complexity of the head unit and multiple assigned functions to each button and each dial, accessing and using the fader and balance controls was difficult and cumbersome. This is especially true if the technician wanted to A/B test two different loudspeakers. Because of these difficulties, the testing of motor vehicle audio systems was slow and the testing procedure would fail to detect defective products.

### SUMMARY

The present invention provides a system and method for testing loudspeakers associated with a motor vehicle. The term “motor vehicle” as used throughout the specification and claims refers to any moving vehicle that is capable of carrying one or more human occupants and is powered by any form of energy. The term motor vehicle includes, but is not limited to cars, trucks, vans, minivans, SUV's, motorcycles, scooters, boats, personal watercraft, and aircraft.

In one aspect, the invention includes a first loudspeaker and a second loudspeaker both loudspeakers being connected to the audio system, a diagnostic mode where a test signal is sent to the first loudspeaker while the second loudspeaker receives no intended signal, and where the test signal moves to the second loudspeaker and the first loudspeaker receives no intended signal after receiving an input from a user.

In another aspect, entry into the diagnostic mode requires input from a plurality of keys.

In another aspect, the plurality of keys are non-adjacent.

In another aspect, the entry into diagnostic mode requires the plurality of keys to be depressed while the audio system is powered on.

In another aspect, visual feedback is provided when the audio system enters the diagnostic mode.

In another aspect, the audio system includes two additional loudspeakers, a third loudspeaker and a fourth loudspeaker.

In another aspect, the four loudspeakers are placed in a sequential order and the audio system moves the test signal from a currently tested loudspeaker to a next loudspeaker in the sequence in response to a first input.

In another aspect, the audio system moves the test signal from a currently tested loudspeaker to a previous loudspeaker in the sequence in response to a second input.

In another aspect, the audio system exits the diagnostic mode in response to an input from a user.

In another aspect, the invention includes a method for diagnosing an audio system for a motor vehicle comprising the following steps: entering a diagnostic mode, pressing a first button to move a test signal from a first loudspeaker to a second loudspeaker, pressing a first button a second time to move the test signal from the second loudspeaker to a third loudspeaker, and pressing a second button to exit the diagnostic mode.

In another aspect, the diagnostic mode is entered by pressing two non-adjacent buttons.

In another aspect, the diagnostic mode is entered by pressing and holding down two non-adjacent buttons while powering up the audio system.

In another aspect, a total of N loudspeakers are associated with the audio system, and by pressing the first button repeatedly, the test signal is eventually sent to the Nth loudspeaker.

In another aspect, pressing a fourth button exits the diagnostic mode.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is an isometric view of a preferred embodiment of a motor vehicle in accordance with the present invention.

FIG. 2 is a schematic diagram of a preferred embodiment of a motor vehicle and associated loudspeakers in accordance with the present invention.

FIG. 3 is a schematic diagram of a preferred embodiment of a vehicle interior in accordance with the present invention.

FIG. 4 is a schematic diagram of a preferred embodiment of a head unit in accordance with the present invention.

FIG. 5 is an enlarged view of a preferred embodiment of a control pod in accordance with the present invention.

FIG. 6 is a flow diagram of a preferred embodiment of a method for testing loudspeakers in accordance with the present invention.

FIG. 7 is a schematic diagram of a preferred embodiment of a lower portion of a center console in accordance with the present invention.

FIG. 8 is a schematic diagram of a preferred embodiment of a lower portion of a center console including visual feedback in accordance with the present invention.

FIG. 9 is a flow diagram of a preferred embodiment of a testing sequence of loudspeakers in accordance with the present invention.

### DETAILED DESCRIPTION OF THE PREFERRED EMBODIMENT(S)

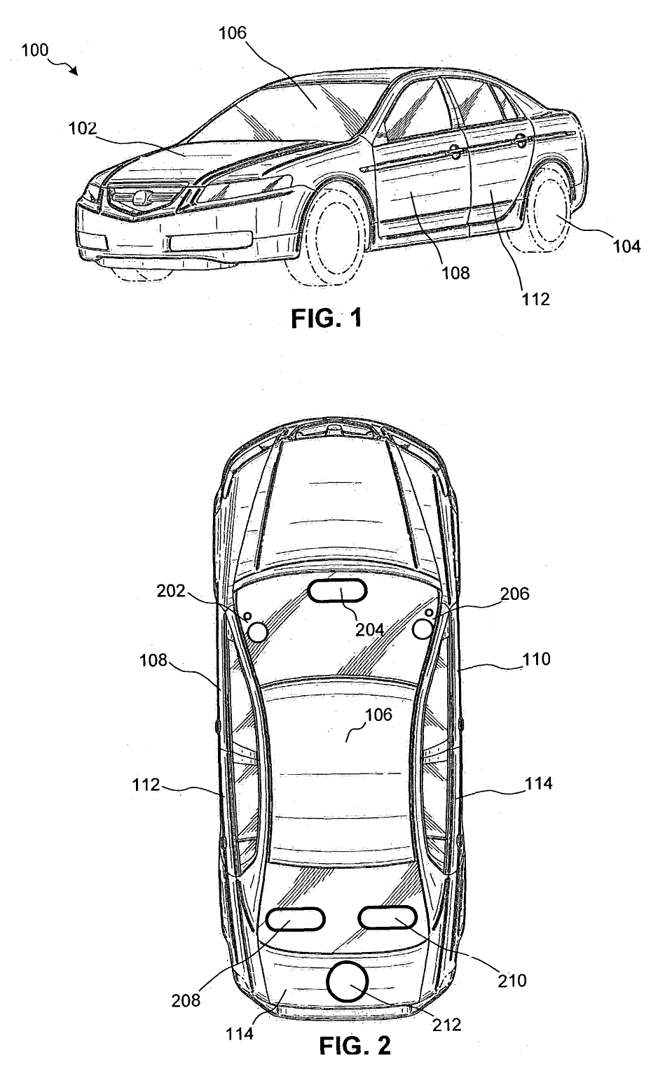

FIGS. 1 and 2 are schematic views of a preferred embodiment of a motor vehicle 100. Motor vehicle 100 includes a body 102 and at least one wheel 104. Body 102 includes a passenger cabin 106 and at least one door 108 that provides access to passenger cabin 106. In the embodiment shown in FIGS. 1 and 2, motor vehicle 100 includes four doors, a left front door 108 and a right front door 110, and left rear door 112 and right rear door 114.

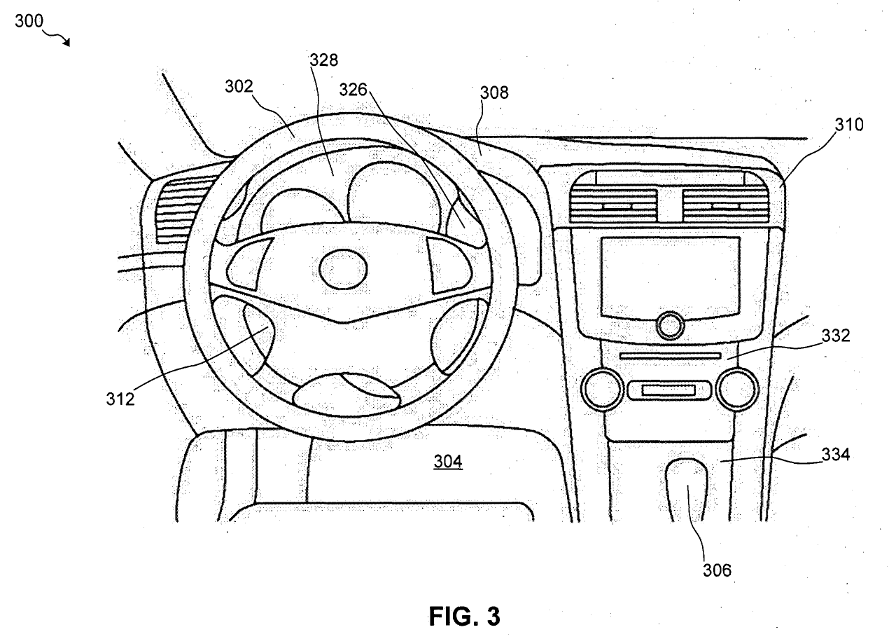

Preferably, motor vehicle 100 includes an audio system 302 (see FIG. 3) and at least one loudspeaker associated with audio system 302. Preferably, motor vehicle includes a plurality, that is, more than two loudspeakers disposed-about passenger cabin 106. In the preferred embodiment shown in FIG. 2, motor vehicle includes six loudspeaker assemblies.

As shown schematically in FIG. 2, motor vehicle includes left front loudspeaker 202, center front loudspeaker 204, right front loudspeaker 206, left rear loudspeaker 208, right rear loudspeaker 210 and a subwoofer 212. Again, FIG. 2 does not show the actual size, placement or design of the loudspeakers, instead, FIG. 2 is a schematic diagram showing preferred relative locations of the loudspeakers with respect to each other.

The term “loudspeaker” is used to refer to any loudspeaker assembly. For example, loudspeaker can refer to a single driver or transducer, a coaxial system including two or more drivers, and/or a component system including two or more physically separate drivers and signal processing devices like crossovers and similar items.

Preferably, left front loudspeaker 202 and right front loudspeaker 206 are component systems with a door mounted midrange driver and a tweeter mounted above the midrange driver. Preferably, subwoofer 212 is mounted outside of passenger cabin 106 and in trunk 114 of motor vehicle 100.

Passenger cabin 106 includes an interior 300, a preferred embodiment of which is shown in FIG. 3. Interior 300 includes steering wheel 302, driver's seat 304, shifter or gear selector 306, dashboard 308 and center console 310. Center console 310 includes an audio system 332 and a lower portion 334. Audio system 332 is also sometimes referred to as a head unit.

In a preferred embodiment, steering wheel 302 includes a control pad 312 mounted onto a lower portion of steering wheel 302. In addition, some embodiments include a multi-function display 326 disposed on dashboard 308. Multi-function display 326 can show audio system information and status. In some embodiments, multi-function display 326 is disposed within instrument cluster 328 on dashboard 308.

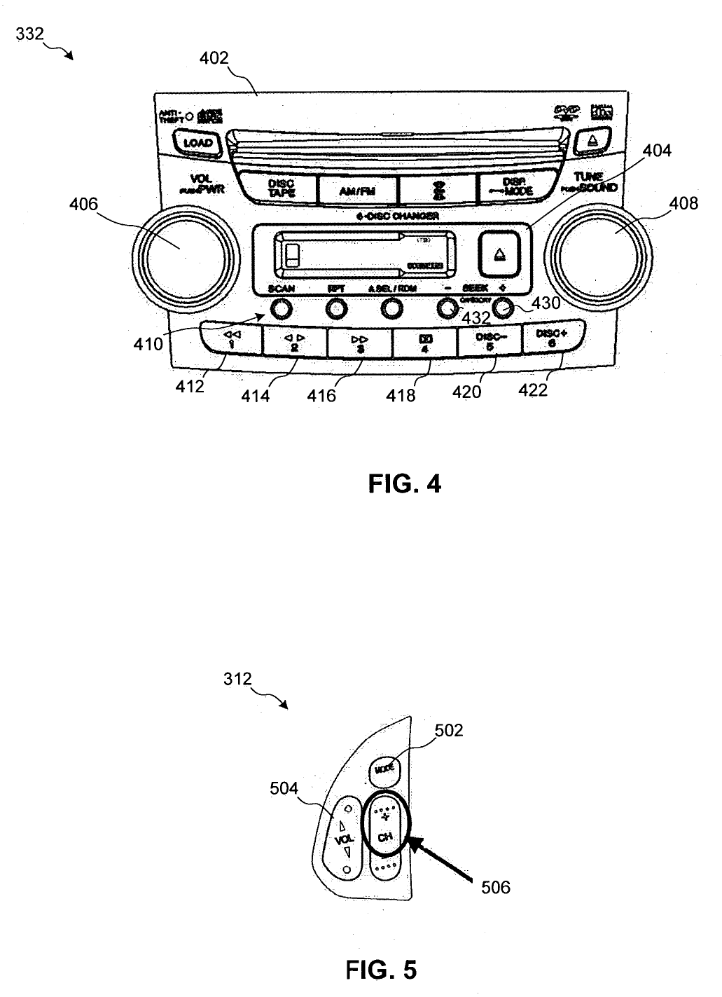

FIG. 4 is an enlarged view of audio system 332. Audio system 332 can be any audio system for a motor vehicle and can include one or more of the following features, a radio tuner, a cassette tape player, a CD player, a CD changer control, a DVD player, and/or MiniDisc player. In the embodiment shown in FIG. 4, audio system 332 includes a CD player and CD changer control portion 402, and a cassette tape player portion 404.

Audio system 332 also includes a power and volume knob 406, a tune and sound adjust knob 408, and a series of smaller buttons 410. Audio system 332 also includes the following multifunction buttons. Preferably, these buttons provide different functions depending on which source is being played or the current mode of operation of audio system 332.

Button 412 is used to rewind or reverse the audio program. If audio system 332 is playing a cassette tape, button 412 is used to rewind the tape. If audio system 332 is playing a CD, button 412 is used to review the CD and/or move back one track. Also, if audio system 332 is in tuner mode, button 412 is used to tune to a first preset radio station. The remaining buttons 414-422 are similarly multifunctional and operate as conventionally known in the art. In some cases, a button will perform no function in a certain mode. For example, button 418 selects Dolby noise reduction in cassette mode, but performs no function in CD playback mode.

In addition to the buttons and controls provided on audio system 332, some embodiments include audio controls mounted on a control pod 312 on steering wheel 302. FIG. 5 is an enlarged view of control pod 312, and shows a preferred embodiment of the controls and buttons provided. Preferably, control pod 312 includes a mode button 502, a volume rocker switch 504, and a channel rocker switch 506.

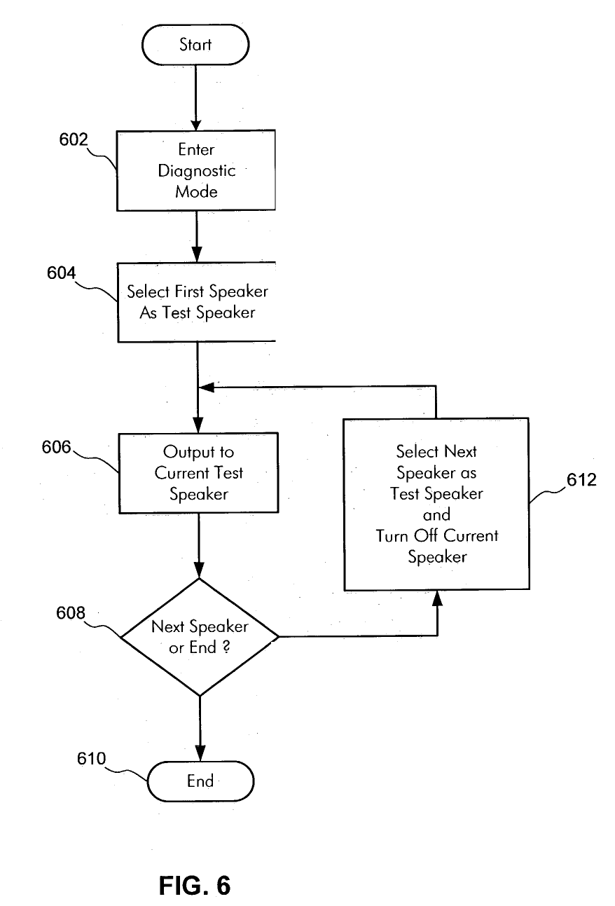

FIG. 6 is a preferred embodiment of a flow diagram of a system and method for commencing a diagnostic mode and conducting a diagnostic of one or more loudspeakers of an audio system in a motor vehicle. The process starts in step 602 when a technician or user enters a diagnostic mode. There are many ways to enter the diagnostic mode. Preferably, a key combination that is unlikely to be inadvertently struck is selected. This can include two or more non-adjacent keys. Also, the system may require multiple keys to be pressed and held down for a period of time and/or until another button or key is pressed. In other embodiments, the system can only enter diagnostic mode when the system is off and in other embodiments, the system can only enter diagnostic mode when the system is on.

In a preferred embodiment, the diagnostic mode is commenced when multiple keys are held down and the system is powered on. Referring to FIG. 4, an exemplary embodiment of commencing the diagnostic mode includes pressing and holding down buttons 412 and 416 while audio system 332 is powered on by pressing volume and power button 406.

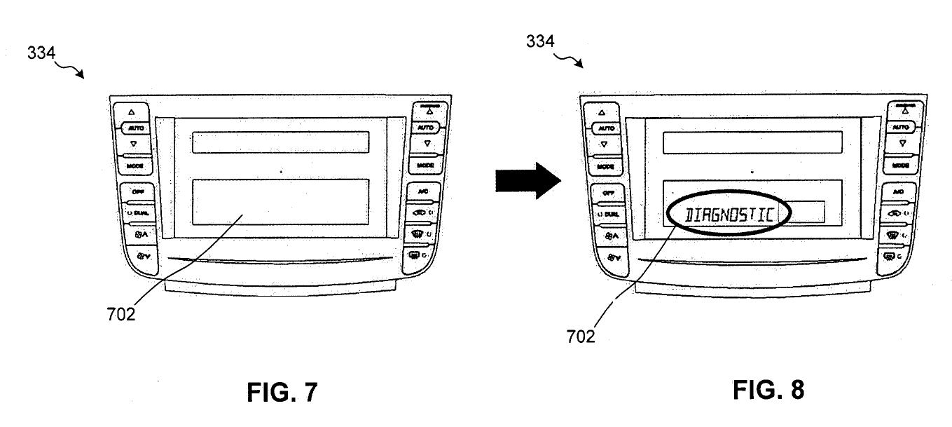

In some embodiments, audio system 332 provides some kind of feedback to let the technician know that audio system 332 has entered a diagnostic mode. In a preferred embodiment, visual feedback is used. FIGS. 7 and 8, which show a lower portion 334 (see FIG. 3) of center console 310 (see FIG. 3), show an exemplary embodiment of visual feedback.

FIGS. 7 and 8 show a preferred embodiment of a lower portion 334. Preferably, lower portion 334 includes a display portion 702. FIG. 7 shows lower portion 334 just prior to entering diagnostic mode. Preferably, when the diagnostic mode is entered, some indicia, for example, the word “diagnostic” is displayed in display portion 702, as shown in FIG. 8, which shows lower portion 334 after diagnostic mode has been entered.

After audio system 332 has entered the diagnostic mode, audio system 332 selects a first loudspeaker as the test speaker in step 604. Any desired loudspeaker can be selected as the first loudspeaker to be tested. Preferably, the right front loudspeaker 206 (see FIG. 2) is selected as the first loudspeaker to be tested.

After the first loudspeaker is selected, a signal is output to that speaker in step 606. Any signal can be used. In some embodiments, audio system 332 generates a test tone, for example white noise or pink noise. In other embodiments, the tuner is used to generate a test signal. Preferably, a strong FM station is used to generate the test signal. Of course, any FM station can be used to provide the test signal. This FM station frequency can be pre-programmed as the test signal or the FM frequency can be selected by the technician. In an exemplary embodiment, FM frequency 97.9 MHz is used.

Preferably, the test signal is output to only the loudspeaker being tested and other loudspeakers are not intentionally provided with a signal. Some small about of signal may be sent to the other loudspeakers due to channel cross talk, but this is an inevitable phenomenon of most multi-channel systems and this cross talk is not considered an intentional signal.

Preferably, audio system 332 (see FIG. 3) continues to send a signal to the loudspeaker being tested. In other words, it is preferred that there is no device time out or a situation where the output signal is discontinued after a preset period of time, although this could be provided as a feature.

In step 608, audio system 332 awaits an input from the technician. Preferably, audio system 332 is providing an output to the loudspeaker being testing while waiting for an input from the technician. If a power off command is received at step 608, then the diagnostic mode ends and audio system 332 powers down. Preferably, if a power off command is received at any time audio system 332 is in the diagnostic mode, then the diagnostic mode ends and audio system 332 powers down. Although the power down command is the preferred method of exiting the diagnostic mode, other commands or buttons or button combinations can be used to exit the diagnostic mode.

In addition to the power down command, audio system 332 also responds to other commands as well. The technician can select the next loudspeaker in step 612. Any method, key stroke or key combination can be used to instruct audio system 332 to proceed to the next loudspeaker. However, the use of the channel up and down buttons is preferred.

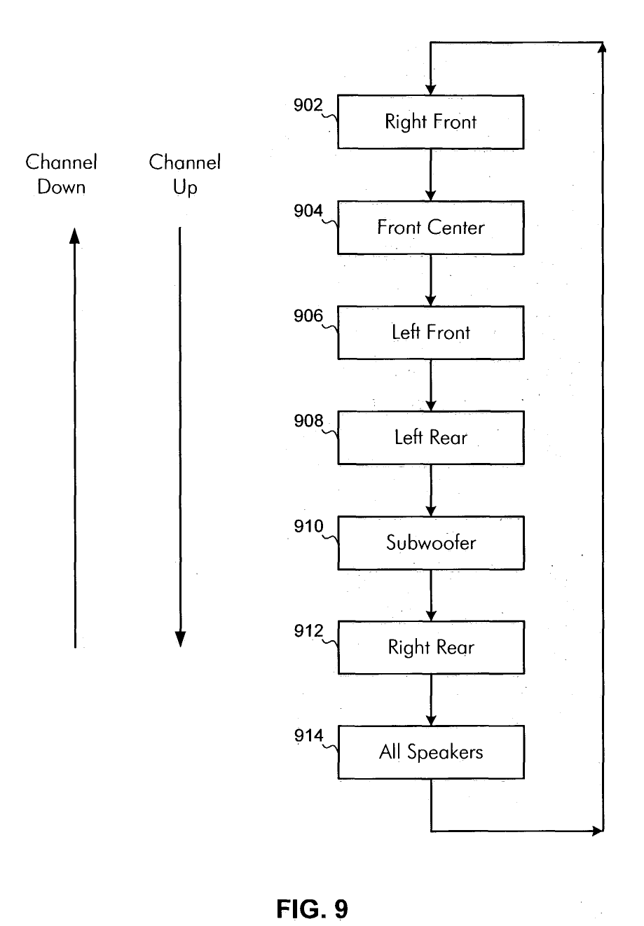

FIG. 9 is a flow diagram of a preferred embodiment of a loudspeaker selection sequence 900. Referring to FIGS. 2 and 9, preferably, the first loudspeaker selected for testing is right front speaker 206 in step 902. The next speaker in sequence 900 is front center speaker 204 in step 904. The next speaker in sequence 900 is front left speaker 202 in step 906. The next speaker in sequence 900 is rear left speaker 208 in step 908. The next speaker in sequence 900 is subwoofer 212 in step 910. And finally, the last individual speaker in sequence 900 is rear right speaker 210 in step 912. Preferably, all of the speakers are then tested simultaneously in step 914. Preferably, sequence 900 loops back to step 902 from step 914. Preferably, this loop works both ways and it is possible to jump from step 902 to step 914 if desired.

The loudspeakers associated with audio system 332 can be placed in any desired sequence or logical order. The sequence shown in FIG. 9 is merely a preferred sequence. In some embodiments, some of the steps of sequence 900 are omitted. For example, if a motor vehicle has less than six loudspeakers, those speakers that are not present would be omitted. Also, it is possible to omit step 914 where all speakers are played simultaneously.

Buttons associated with audio system 332 can be used to progress through sequence 900. In some embodiments, different buttons can be used to progress through sequence 900 in different directions. In some embodiments, redundant controls can also be provided where two different buttons perform the same function. In a preferred embodiment, the channel up and down buttons and the seek left and seek right buttons are used to progress through sequence 900 in two directions.

Referring to FIG. 5, pressing the upper portion of channel rocker switch 506 provides a channel up command and pressing the lower portion of channel rocker switch 506 provides a channel down command. Preferably, the channel up command is used to progress through sequence 900 as indicated in FIG. 9. When the channel up button is pressed, sequence 900 progresses from step 902 to step 904 and so forth. When sequence reaches step 914 and a channel up command is received, then sequence 900 proceeds to step 902. Preferably, the channel down button is used to progress through sequence 900 in the opposite direction. So, if sequence 900 is at step 904, pressing the channel down button will move sequence 900 to step 902. An additional channel down input will then move sequence 900 to step 914 and so forth.

Preferably, redundant buttons are also provided. In an exemplary embodiment, seek (+) button 430 (see FIG. 4) has the same function as the channel up button and seek (−) button 432 (see FIG. 4) has the same function as the channel down button. Either set of buttons can be used at any time. In other words, a technician can use either set of buttons during diagnostic mode.

Using the features described above, a technician can easily test each loudspeaker independently and determine its operating capabilities. In this way, each loudspeaker is tested individually and also together as a set. At the end of a testing session or at any time during the test, a technician can exit diagnostic mode by pressing the power button. Audio system 332 (see FIG. 3) will power down and will then be ready for normal operation.

While various embodiments of the invention have been described, it will be apparent to those of ordinary skill in the art that may more embodiments and implementations are possible that are within the scope of the invention. Accordingly, the invention is not to be restricted except in light of the attached claims and their equivalents.

1. An audio system in a motor vehicle including a body, at least one wheel, a steering wheel and a passenger cabin comprising:
a first loudspeaker and a second loudspeaker both loudspeakers being connected to the audio system;
a diagnostic mode wherein a test signal is sent to the first loudspeaker while the second loudspeaker receives no intended signal, and wherein the test signal moves to the second loudspeaker and the first loudspeaker receives no intended signal after receiving an input from a user.

2. The audio system according to claim 1, wherein entry into the diagnostic mode requires input from a plurality of keys.

3. The audio system according to claim 2, wherein the plurality of keys are non-adjacent.

4. The audio system according to claim 4, wherein the entry into diagnostic mode requires the plurality of keys to be depressed while the audio system is powered on.

5. The audio system according to claim 2, wherein visual feedback is provided when the audio system enters the diagnostic mode.

6. The audio system according to claim 1, further comprising two additional loudspeakers, a third loudspeaker and a fourth loudspeaker.

7. The audio system according to claim 6, wherein the four loudspeakers are placed in a sequential order and wherein audio system moves the test signal from a currently tested loudspeaker to a next loudspeaker in the logical order in response to a first input.

8. The audio system according to claim 7, wherein the audio system moves the test signal from a currently tested loudspeaker to a previous loudspeaker in the sequential order in response to a second input.

9. The audio system according to claim 1, wherein the audio system exits the diagnostic mode in response to an input from a user.

10. A method for diagnosing an audio system for a motor vehicle comprising the steps of:
entering a diagnostic mode;
pressing a first button to move a test signal from a first loudspeaker to a second loudspeaker;
pressing a first button a second time to move the test signal from the second loudspeaker to a third loudspeaker;
pressing a second button to exit the diagnostic mode.

11. The method according to claim 10, wherein the diagnostic mode is entered by pressing two non-adjacent buttons.

12. The method according to claim 10, wherein the diagnostic mode is entered by pressing and holding down two non-adjacent buttons while powering up the audio system.

13. The method according to claim 10, wherein pressing a third button moves the test signal from the third loudspeaker back to the second loudspeaker.

14. The method according to claim 13, wherein pressing the third button a second time moves the test signal from the second loudspeaker back to the first loudspeaker.

15. The method according to claim 10, wherein a total of N loudspeakers are associated with the audio system, and by pressing the first button repeatedly, the test signal is eventually sent to the Nth loudspeaker.

16. The method according to claim 10, wherein sending a signal to all of the loudspeakers is part of a testing sequence.

17. The method according to claim 10, wherein pressing a fourth button exits the diagnostic mode.

17. The method according to claim 10, wherein output to all of the loudspeakers is part of the testing sequence.

18. An audio system for a motor vehicle including:
a head unit mounted to a center console;
a plurality of loudspeakers including a right front loudspeaker, a front center loudspeaker mounted to a dashboard, a left front loudspeaker, a left rear loudspeaker, a subwoofer, and a right rear loudspeaker, all of the speakers being connected to the head unit;
the head unit having a diagnostic mode where a test signal is sent to one of the plurality of loudspeakers while the remaining loudspeakers receive no intended signal; and
wherein all of the loudspeakers, including the subwoofer, are placed in a testing order.

19. The audio system according to claim 18, wherein a first single button is used to move the test signal through the testing order in a first direction and a second single button is used to move the test signal through the testing order in a second direction.

20. The audio system according to claim 18, wherein a third single button is used to exit the diagnostic mode.
